(19) United States
(12) Patent Application Publication
(10) Pub. No.: US 2025/0257489 A1
(43) Pub. Date: Aug. 14, 2025

(54) WATER ELECTROLYSIS SYSTEM

(71) Applicant: HONDA MOTOR CO., LTD., TOKYO (JP)

(72) Inventor: Kazunori FUKUMA, WAKO-SHI (JP)

(21) Appl. No.: 19/023,925

(22) Filed: Jan. 16, 2025

(30) Foreign Application Priority Data
Feb. 14, 2024 (JP) 2024-020103

(51) Int. Cl. C25B 15/08; C25B 9/23; C25B 9/77; C25B 15/029

(52) U.S. Cl. CPC C25B 15/085; C25B 9/23; C25B 9/77; C25B 15/029

(57) ABSTRACT

A water electrolysis system includes: a water electrolysis stack that generates oxygen gas and hydrogen gas by electrolyzing water; a gas-liquid separator that separates the hydrogen gas from water; a hydrogen compression stack that compresses the hydrogen gas; a gas tank that stores an inert gas and is connected to a hydrogen flow path that connects the water electrolysis stack and the hydrogen compression stack; a supply valve that, when opened, supplies the inert gas to the hydrogen flow path; and a supply control unit that opens the supply valve in a case where the concentration of the oxygen gas that has flowed into the hydrogen flow path exceeds an oxygen concentration threshold determined in advance.

### CROSS-REFERENCE TO RELATED APPLICATIONS

This application is based upon and claims the benefit of priority from Japanese Patent Application No. 2024-020103 filed on Feb. 14, 2024, the contents of which are incorporated herein by reference.

### BACKGROUND OF THE INVENTION

### Field of the Invention

The present disclosure relates to a water electrolysis system.

### Description of the Related Art

In recent years, research and development have been conducted on fuel cells that contribute to energy efficiency in order to ensure that more people have access to affordable, reliable, sustainable and modern energy.

JP 2022-083098 A discloses a hydrogen/oxygen producing system. Oxygen gas and hydrogen gas generated by the hydrogen/oxygen producing system can be supplied to a tank for a fuel cell or the like. The hydrogen/oxygen producing system includes a water electrolysis apparatus. In the water electrolysis apparatus, water is electrolyzed by a current flowing through an anode and a cathode provided on both surfaces of an electrolyte membrane. Hydrogen gas is generated at the cathode, and high-pressure oxygen gas is generated at the anode. Oxygen gas is less likely to permeate through the electrolyte membrane than hydrogen gas. Since the oxygen gas is at a high pressure, the occurrence of crossover in which hydrogen permeates through the electrolyte membrane is suppressed.

### SUMMARY OF THE INVENTION

Recently, it has been desired to improve safety when an abnormality occurs in a water electrolysis system.

The present invention has the object of solving the aforementioned problem, thereby contributing to energy efficiency.

According to an aspect of the present disclosure, there is provided a water electrolysis system, comprising: a water electrolysis stack including a membrane electrode assembly in which an electrolyte membrane is sandwiched between an anode and a cathode, the water electrolysis stack being configured to generate oxygen gas and hydrogen gas by electrolyzing water; a gas-liquid separator configured to separate the hydrogen gas generated by the water electrolysis stack from water that has not been electrolyzed by the water electrolysis stack; a hydrogen compression stack including a membrane electrode assembly in which an electrolyte membrane is sandwiched between an anode and a cathode, the hydrogen compression stack being configured to compress the hydrogen gas separated by the gas-liquid separator; a gas tank configured to store an inert gas and connected to a hydrogen flow path that connects the water electrolysis stack and the hydrogen compression stack to each other via the gas-liquid separator; a supply valve configured to, when opened, supply the inert gas stored in the gas tank to the hydrogen flow path; and a supply control unit configured to open the supply valve in a case where an oxygen concentration, which is a concentration of oxygen gas that has flowed into the hydrogen flow path, exceeds an oxygen concentration threshold determined in advance.

According to the present invention, safety when an abnormality occurs in the water electrolysis system can be improved.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating a configuration of a water electrolysis system according to an embodiment;

FIG. 2 is a flowchart showing an operation example of a control device;

FIG. 3 is a diagram illustrating a configuration of the water electrolysis system according to a modification; and

FIG. 4 is a flowchart showing an operation example of the control device.

### DETAILED DESCRIPTION OF THE INVENTION

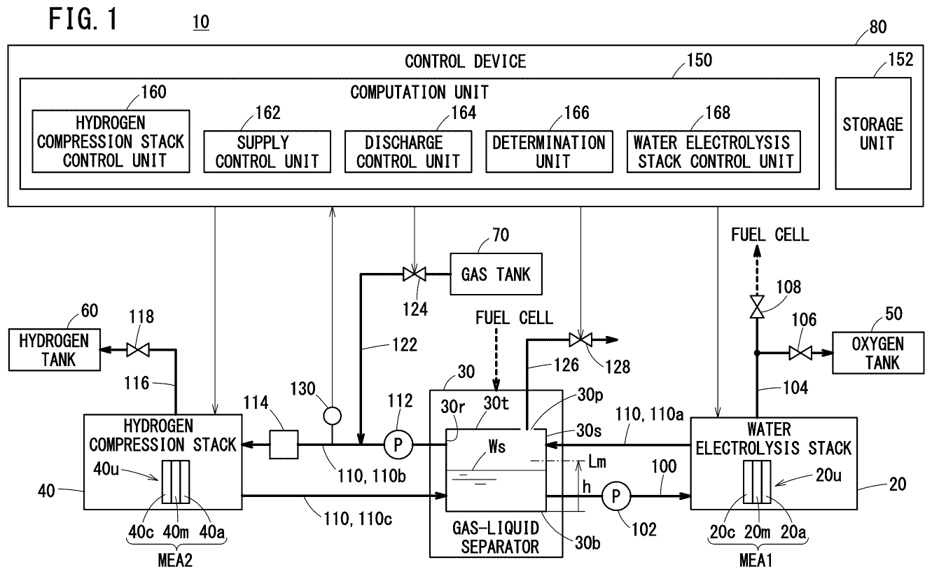

A water electrolysis system according to an embodiment will be described with reference to the drawings. FIG. 1 is a diagram illustrating a configuration of a water electrolysis system 10 according to the present embodiment. The water electrolysis system 10 includes a water electrolysis stack 20, a gas-liquid separator 30, a hydrogen compression stack 40, an oxygen tank 50, a hydrogen tank 60, a gas tank 70, and a control device 80.

The water electrolysis stack 20 generates oxygen gas and hydrogen gas by electrolyzing water. The water is supplied from the gas-liquid separator 30. The gas-liquid separator 30 separates the hydrogen gas generated by the water electrolysis stack 20 from the water that has not been electrolyzed by the water electrolysis stack 20. The gas-liquid separator 30 stores the separated water. The hydrogen compression stack 40 compresses the hydrogen gas separated by the gas-liquid separator 30. The oxygen tank 50 stores the oxygen gas generated by the water electrolysis stack 20. The hydrogen tank 60 stores the hydrogen gas compressed by the hydrogen compression stack 40.

The oxygen gas stored in the oxygen tank 50 and the hydrogen gas stored in the hydrogen tank 60 are used in a member other than the water electrolysis system 10. The other member is, for example, a fuel cell. A part of the oxygen gas generated by the water electrolysis stack 20 may be supplied to the fuel cell without being stored. A part of the hydrogen gas compressed by the hydrogen compression stack 40 may be supplied to the fuel cell without being stored. The gas tank 70 stores an inert gas. The inert gas is, for example, nitrogen gas or noble gas. The control device 80 controls respective members constituting the water electrolysis system 10. Details of the control by the control device 80 will be described later.

The water electrolysis system 10 includes a water supply flow path 100 and a pump 102. The water supply flow path 100 is a flow path that connects the gas-liquid separator 30 and the water electrolysis stack 20. The pump 102 sucks water stored in the gas-liquid separator 30, and discharges the water to the water supply flow path 100. The water discharged by the pump 102 flows through the water supply flow path 100 and is supplied to the water electrolysis stack 20.

A plurality of unit cells 20u are stacked in the water electrolysis stack 20. Each of the unit cells 20u electrolyzes water. The unit cells 20u each include a membrane electrode assembly MEA1. The membrane electrode assembly MEAL includes an electrolyte membrane 20m, an anode 20a, and a cathode 20c. The electrolyte membrane 20m is sandwiched between the anode 20a and the cathode 20c. The electrolyte membrane 20m is, for example, an anion exchange membrane. Hydroxide ions OH⁻, which will be described later, can be conducted through the anion exchange membrane.

A voltage is applied from a power supply to the anode 20a and the cathode 20c. A potential difference is generated between the anode 20a and the cathode 20c. The water supplied to the water electrolysis system 10 receives electrons from the cathode 20c. That is, a reduction reaction occurs. This reduction reaction generates hydrogen gas (H₂) and hydroxide ions OH⁻ at the cathode 20c.

The hydroxide ions OH-generated at the cathode 20c are conducted to the anode 20a by the electrolyte membrane 20m in accordance with the potential difference between the two electrodes. An oxidation reaction occurs at the anode 20a. The hydroxide ions OH-release electrons to the anode 20a by the oxidation reaction. As a result, oxygen gas (02) and water (H₂O) are generated at the anode 20a.

The water electrolysis system 10 includes an oxygen supply flow path 104, a back pressure valve 106, and a pressure regulating valve 108. The oxygen supply flow path 104 includes a flow path that connects the water electrolysis stack 20 and the oxygen tank 50, and a flow path that connects the water electrolysis stack 20 and the fuel cell. The back pressure valve 106 is provided in the flow path that connects the water electrolysis stack 20 and the oxygen tank 50. The pressure regulating valve 108 is provided in the flow path that connects the water electrolysis stack 20 and the fuel cell.

The oxygen gas generated at the anode 20a by the water electrolysis stack 20 flows through the oxygen supply flow path 104 and is supplied to the oxygen tank 50 and the fuel cell. The back pressure valve 106 keeps the pressure of the oxygen gas flowing from the anode 20a to the back pressure valve 106 and the pressure of the oxygen gas flowing from the anode 20a to the pressure regulating valve 108 higher than the pressure of the hydrogen gas generated at the cathode 20c. In this manner, a differential pressure is generated across the electrolyte membrane 20m.

The differential pressure generated across the electrolyte membrane 20m causes water (water molecules) produced at the anode 20a to diffuse through the electrolyte membrane 20m and move to the cathode 20c. The water that has moved to the cathode 20c is used for the above-described reduction reaction at the cathode 20c. The differential pressure across the electrolyte membrane 20m reduces the crosstalk in which the hydrogen gas generated at the cathode 20c moves to the anode 20a.

The water electrolysis system 10 includes a hydrogen flow path 110. The hydrogen flow path 110 is a flow path that connects the water electrolysis stack 20 and the hydrogen compression stack 40 to each other via the gas-liquid separator 30. As shown in FIG. 1, the hydrogen flow path 110 includes a section 110a between the water electrolysis stack 20 and the gas-liquid separator 30, a section 110b between the gas-liquid separator 30 and the hydrogen compression stack 40, and a section 110c between the gas-liquid separator 30 and the hydrogen compression stack 40, which is different from the section 110b.

The hydrogen gas generated at the cathode 20c by the water electrolysis stack 20, and the water that has not been electrolyzed by the water electrolysis stack 20 flow through the section 110a of the hydrogen flow path 110 and are separated by the gas-liquid separator 30. Water contained in a reactant off-gas discharged from the above-described fuel cell further flows into the gas-liquid separator 30. The water separated by the gas-liquid separator 30 is stored upward from a bottom part 30b of the gas-liquid separator 30 by the action of gravity. The hydrogen gas is located above the stored water.

In FIG. 1, a storable water level Lm of the gas-liquid separator 30 is shown at a position of a height h from the bottom part 30b of the gas-liquid separator 30. The water level of the water stored in the gas-liquid separator 30 is maintained at the storable water level Lm or lower. As described above, the water stored in the gas-liquid separator 30 can flow through the water supply flow path 100 and be supplied to the water electrolysis stack 20.

The hydrogen gas stored in the gas-liquid separator 30 can flow through the section 110b of the hydrogen flow path 110 and be supplied to the hydrogen compression stack 40. The water electrolysis system 10 includes a pump 112. The pump 112 sucks the hydrogen gas separated by the gas-liquid separator 30 and discharges the hydrogen gas to the section 110b of the hydrogen flow path 110. The hydrogen gas discharged from the pump 112 flows through the section 110b of the hydrogen flow path 110 and is supplied to the hydrogen compression stack 40.

A part of the reactant off-gas discharged from the fuel cell may be mixed in the water flowing into the gas-liquid separator 30 from the fuel cell. The reactant off-gas may contain oxygen gas. Therefore, the oxygen gas may be mixed with the hydrogen gas in the hydrogen flow path 110. The water electrolysis system 10 includes an oxygen removal device 114. The oxygen removal device 114 includes a catalyst such as palladium. The catalyst is disposed in the section 110b of the hydrogen flow path 110 to remove the oxygen gas present in the hydrogen flow path 110.

A plurality of unit cells 40u are stacked in the hydrogen compression stack 40. Each of the unit cells 40u compresses the hydrogen gas. The unit cells 40u each include a membrane electrode assembly MEA2. The membrane electrode assembly MEA2 includes an electrolyte membrane 40m, an anode 40a, and a cathode 40c. The electrolyte membrane 40m is sandwiched between the anode 40a and the cathode 40c. The electrolyte membrane 40m is, for example, a proton exchange membrane. Protons, which are a type of hydrogen ion H⁺, can be conducted through the proton exchange membrane.

A voltage is applied from a power supply to the anode 40a and the cathode 40c. A potential difference is generated between the anode 40a and the cathode 40c. The hydrogen gas supplied to the hydrogen compression stack 40 emits electrons at the anode 40a. As a result, protons are generated at the anode 40a. The protons generated at the anode 40a are conducted to the cathode 40c by the electrolyte membrane 40m in accordance with the potential difference between the two electrodes. The protons (H⁺) conducted from the anode 40a to the cathode 40c receive electrons from the cathode 40c. As a result, high-pressure compressed hydrogen gas (H₂) is generated at the cathode 40c.

The water electrolysis system 10 includes a hydrogen supply flow path 116 and a back pressure valve 118. The hydrogen supply flow path 116 is a flow path that connects the hydrogen compression stack 40 and the hydrogen tank 60. The back pressure valve 118 is provided in the hydrogen supply flow path 116. The hydrogen gas generated at the cathode 40c by the hydrogen compression stack 40 can flow through the hydrogen supply flow path 116 and be supplied to the hydrogen tank 60.

The hydrogen gas generated at the cathode 40c is at a high pressure as described above. The back pressure valve 118 keeps the pressure of the hydrogen gas flowing from the cathode 40c to the back pressure valve 118 higher than the pressure of the hydrogen gas supplied to the anode 40a. The hydrogen gas that has not been compressed by the hydrogen compression stack 40 flows through the section 110c of the hydrogen flow path 110 and returns to the gas-liquid separator 30.

As described above, in the water electrolysis stack 20, the oxygen gas generated at the anode 20a is kept at a higher pressure than the hydrogen gas generated at the cathode 20c.

That is, the internal pressure of the hydrogen flow path 110 is lower than the pressure of the oxygen gas flowing from the anode 20a to the back pressure valve 106 or the pressure regulating valve 108.

It is assumed that the electrolyte membrane 20m is damaged in one or a plurality of unit cells 20u of the water electrolysis stack 20 due to some abnormality in the water electrolysis stack 20. In this case, a large amount of high-pressure oxygen gas may flow into the low-pressure hydrogen flow path 110. When a large amount of oxygen gas flows into the hydrogen flow path 110, the oxygen removal device 114 cannot completely remove the oxygen gas, and the oxygen gas may reach the hydrogen compression stack 40.

Since a voltage has been applied to the plurality of unit cells 40u of the hydrogen compression stack 40, if not only the hydrogen gas but also the oxygen gas is supplied to the hydrogen compression stack 40, safety may be reduced. In addition, in the oxygen removal device 114, a large amount of oxygen gas may come into contact with the catalyst, and thus heat may be generated. The heat generation may also reduce safety.

In order to improve safety, in the water electrolysis system 10 according to the present embodiment, an oxygen concentration, which is the concentration of the oxygen gas that has flowed into the hydrogen flow path 110, is determined. In a case where the oxygen concentration exceeds an oxygen concentration threshold determined in advance, a purge process of the inside of the hydrogen flow path 110 by an inert gas is performed. The oxygen concentration can be reduced by the purge process. This can improve safety when an abnormality occurs in the water electrolysis system 10.

By performing a process of stopping the operation of the water electrolysis stack 20 in parallel with the purge process, the amount of oxygen gas flowing into the hydrogen flow path 110 can be reduced. Further, by performing a process of stopping the operation of the hydrogen compression stack 40 in parallel with the purge process, the voltage application to the plurality of unit cells 40u is stopped. This can further improve safety. A configuration for realizing the purge process of the inside of the hydrogen flow path 110 by the inert gas will be described with reference to FIG. 1.

The gas tank 70 stores a high-pressure inert gas. The water electrolysis system 10 includes a gas supply flow path 122 for the inert gas, and a supply valve 124 for the inert gas. The gas supply flow path 122 is a flow path that connects the gas tank 70 and the section 110b of the hydrogen flow path 110. The gas supply flow path 122 is connected to the hydrogen flow path 110 at a location between the pump 112 and the oxygen removal device 114. That is, the gas tank 70 is connected to the section 110b of the hydrogen flow path 110 on the upstream of the oxygen removal device 114.

The supply valve 124 is provided in the gas supply flow path 122. When the supply valve 124 is opened, the high-pressure inert gas stored in the gas tank 70 is supplied to the section 110b of the hydrogen flow path 110. Consequently, the inert gas supplied to the hydrogen flow path 110 can reduce the oxygen concentration in the hydrogen flow path 110. The inert gas supplied to the hydrogen flow path 110 further flows into the oxygen removal device 114 and the hydrogen compression stack 40, and also reduces the oxygen concentration in the oxygen removal device 114 and the hydrogen compression stack 40.

The high-pressure inert gas flows into the hydrogen flow path 110 in the section 110b downstream of the gas-liquid separator 30, and also flows into the oxygen removal device 114 and the hydrogen compression stack 40, whereby the oxygen concentration can be rapidly reduced. Thereafter, the inert gas flows through the section 110c of the hydrogen flow path 110 and flows into the gas-liquid separator 30.

The inert gas that has flowed into the gas-liquid separator 30 is introduced into a space 30r located above a water surface Ws of the water stored in the gas-liquid separator 30. The inert gas, the oxygen gas, the hydrogen gas, and the like are present in the space 30r. The gas-liquid separator 30 is provided with an opening 30p. The opening 30p is provided at a portion of the gas-liquid separator 30 that is located above the storable water level Lm. The portion of the gas-liquid separator 30 that is located above the storable water level Lm is, for example, a region of a side surface 30s of the gas-liquid separator 30 that is located above the storable water level Lm, or an upper surface 30t of the gas-liquid separator 30. In the example shown in FIG. 1, the opening 30p is provided in the upper surface 30t of the gas-liquid separator 30. This prevents the opening 30p from being submerged in the water stored in the gas-liquid separator 30.

The water electrolysis system 10 includes a discharge flow path 126 and a discharge valve 128. One end of the discharge flow path 126 communicates with the opening 30p of the gas-liquid separator 30. That is, the discharge flow path 126 communicates, via the opening 30p, with the space 30r located above the water surface Ws in the gas-liquid separator 30. The other end of the discharge flow path 126 communicates with the outside.

The discharge valve 128 is provided in the discharge flow path 126. When the discharge valve 128 is opened, the discharge flow path 126 communicates with the outside. In this case, the gas existing in the space 30r in the gas-liquid separator 30 can be discharged to the outside. In this manner, the purge process of the inside of the hydrogen flow path 110 by the inert gas is performed. That is, the oxygen gas in the hydrogen flow path 110 can be discharged to the outside together with the inert gas. Therefore, the oxygen concentration in the hydrogen flow path 110 is sufficiently reduced, and the safety of the water electrolysis system 10 can be further improved.

As described above, the purge process of the inside of the hydrogen flow path 110 by the inert gas is performed in a case where the oxygen concentration exceeds the oxygen concentration threshold determined in advance. Therefore, the water electrolysis system 10 includes a concentration sensor 130 for measuring the oxygen concentration in the hydrogen flow path 110. Oxygen concentration information, which is information about the oxygen concentration measured by the concentration sensor 130, is supplied to the control device 80.

As described above, the control device 80 controls respective members constituting the water electrolysis system 10. The control device 80 includes a computation unit 150 and a storage unit 152. The computation unit 150 includes a processor such as a central processing unit (CPU) or a graphics processing unit (GPU). That is, the computation unit 150 includes processing circuitry.

The storage unit 152 is a computer-readable storage medium. The storage unit 152 includes a volatile memory such as a random access memory (RAM), and a non-volatile memory such as a read only memory (ROM) or a flash memory. The volatile memory is used as a working memory of the processor. The non-volatile memory stores a program executed by the processor, and other necessary data. The program stored in the storage unit 152 is executed to control the respective members constituting the water electrolysis system 10.

The computation unit 150 includes a hydrogen compression stack control unit 160, a supply control unit 162, a discharge control unit 164, a determination unit 166, and a water electrolysis stack control unit 168. The computation unit 150 executes the program stored in the storage unit 152, thereby realizing the hydrogen compression stack control unit 160, the supply control unit 162, the discharge control unit 164, the determination unit 166, and the water electrolysis stack control unit 168.

At least part of the hydrogen compression stack control unit 160, the supply control unit 162, the discharge control unit 164, the determination unit 166, and the water electrolysis stack control unit 168 may be realized by an integrated circuit such as an application specific integrated circuit (ASIC) or a field programmable gate array (FPGA), or an electronic circuit including a discrete device.

The hydrogen compression stack control unit 160 controls the operation of the hydrogen compression stack 40. The water electrolysis stack control unit 168 controls the operation of the water electrolysis stack 20. The supply control unit 162 controls the supply valve 124 for the inert gas. The discharge control unit 164 controls the discharge valve 128 provided in the discharge flow path 126. The determination unit 166 determines whether or not the oxygen concentration, which is the concentration of the oxygen gas that has flowed into the hydrogen flow path 110, has exceeded the oxygen concentration threshold determined in advance. The oxygen concentration threshold is determined in advance by an experiment or the like, and is stored in the storage unit 152.

The water electrolysis stack control unit 168 starts a start-up process for the water electrolysis stack 20. The hydrogen compression stack control unit 160 starts a start-up process for the hydrogen compression stack 40. When the start-up process for the water electrolysis system 10 is started in this manner, the determination unit 166 repeatedly acquires the oxygen concentration information from the concentration sensor 130. The determination unit 166 determines whether or not the oxygen concentration in the hydrogen flow path 110 has exceeded the oxygen concentration threshold based on the acquired oxygen concentration information.

In a case where the determination unit 166 determines that the oxygen concentration has exceeded the oxygen concentration threshold, the supply control unit 162, the discharge control unit 164, the water electrolysis stack control unit 168, and the hydrogen compression stack control unit 160 perform the following control, respectively. Specifically, the supply control unit 162 controls the supply valve 124 to open the supply valve 124. The discharge control unit 164 controls the discharge valve 128 to open the discharge valve 128. The water electrolysis stack control unit 168 controls the water electrolysis stack 20 to start the process of stopping the operation of the water electrolysis stack 20. This suppresses the generation of oxygen gas, and the safety of the water electrolysis system 10 can be therefore further improved.

The hydrogen compression stack control unit 160 controls the hydrogen compression stack 40 to start the process of stopping the operation of the hydrogen compression stack 40. This reduces the possibility that the hydrogen gas and the oxygen gas supplied to the hydrogen compression stack 40 react with each other, and the safety of the water electrolysis system 10 can be therefore further improved.

The water electrolysis stack control unit 168 monitors the operation state of the water electrolysis stack 20, and determines whether or not the process of stopping the operation of the water electrolysis stack 20 has been completed. The hydrogen compression stack control unit 160 monitors the operation state of the hydrogen compression stack 40, and determines whether or not the process of stopping the operation of the hydrogen compression stack 40 has been completed.

In a case where the water electrolysis stack control unit 168 determines that the process of stopping the operation of the water electrolysis stack 20 has been completed, and the hydrogen compression stack control unit 160 determines that the process of stopping the operation of the hydrogen compression stack 40 has been completed, the discharge control unit 164 and the supply control unit 162 perform the following control, respectively. Specifically, the discharge control unit 164 controls the discharge valve 128 to close the discharge valve 128. Further, the supply control unit 162 controls the supply valve 124 to close the supply valve 124.

By the process of stopping the operation of the water electrolysis stack 20 being completed, the generation of the oxygen gas is stopped. The safety of the water electrolysis system 10 can be further improved by stopping the generation of the oxygen gas. Further, by the process of stopping the operation of the hydrogen compression stack 40 being completed, the compression of the hydrogen gas is stopped. The safety of the water electrolysis system 10 can be further improved by stopping the compression of the hydrogen gas.

While the process of stopping the operation of the water electrolysis stack 20 is in progress, the generation of the oxygen gas and the hydrogen gas is continued, but the amounts of generated oxygen gas and generated hydrogen gas are gradually reduced. If the amounts of the generated gases are rapidly reduced, the electrolyte membrane 20m of the water electrolysis stack 20 and the electrolyte membrane 40m of the hydrogen compression stack 40 may be expanded due to the rapid pressure reduction inside the water electrolysis system 10. This may cause further damage to the electrolyte membrane 20m of the water electrolysis stack 20 or the electrolyte membrane 40m of the hydrogen compression stack 40.

In order to prevent such damage, it is necessary to control the pressure reduction rate inside the water electrolysis system 10. Therefore, it is preferable that the supply of the inert gas to the hydrogen flow path 110 is continued. Therefore, the supply control unit 162 does not close the supply valve 124 until the operation of the water electrolysis stack 20 and the operation of the hydrogen compression stack 40 are both stopped. That is, the supply valve 124 is kept open. As a result, the oxygen concentration in the hydrogen flow path 110 is suppressed to be low.

Therefore, the process of stopping the operation of the water electrolysis stack 20 and the process of stopping the operation of the hydrogen compression stack 40 can be performed while preventing further damage to the electrolyte membrane 20m of the water electrolysis stack 20 or the electrolyte membrane 40m of the hydrogen compression stack 40 in a state where the oxygen concentration in the hydrogen flow path 110 is suppressed to be low. Therefore, the safety of the water electrolysis system 10 can be further improved.

In addition, after the operation of the water electrolysis stack 20 and the operation of the hydrogen compression stack 40 are both stopped, the discharge valve 128 is closed. When the discharge valve 128 is closed, even if the outside atmospheric pressure is low or there is no atmosphere outside, the water electrolysis system 10 can be prevented from being damaged due to a pressure drop inside the water electrolysis system 10. Further, by closing the supply valve 124, it is possible to prevent the water electrolysis system 10 from being damaged due to a pressure rise inside the water electrolysis system 10, and to prevent the inert gas stored in the gas tank 70 from being wastefully consumed.

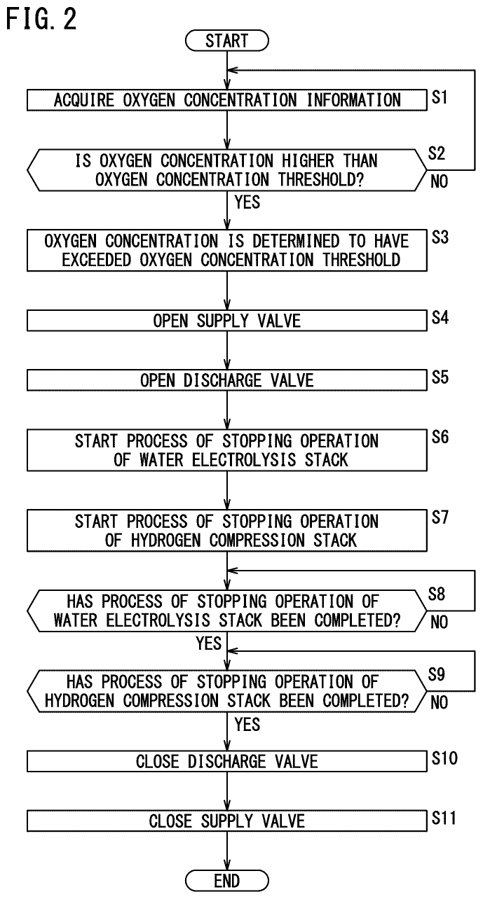

FIG. 2 is a flowchart showing an operation example of the control device 80. When the start-up process for the water electrolysis system 10 is started, a safety control process procedure for the water electrolysis system 10 shown in FIG. 2 is started. This process procedure is performed by the computation unit 150 of the control device 80 executing a program stored in the storage unit 152.

When this process procedure is started, the determination unit 166 acquires the oxygen concentration information from the concentration sensor 130 in step S1. In step S2, the determination unit 166 determines whether or not the oxygen concentration in the hydrogen flow path 110 indicated by the oxygen concentration information acquired in step S1 is higher than the oxygen concentration threshold stored in the storage unit 152. If the determination result in step S2 is affirmative (YES), the process procedure proceeds to step S3. If the determination result in step S2 is negative (NO), the process procedure returns to step S1.

In step S3, the determination unit 166 determines that the oxygen concentration in the hydrogen flow path 110 has exceeded the oxygen concentration threshold. In step S4, the supply control unit 162 opens the supply valve 124. In step S5, the discharge control unit 164 opens the discharge valve 128.

In step S6, the water electrolysis stack control unit 168 starts the process of stopping the operation of the water electrolysis stack 20. In step S7, the hydrogen compression stack control unit 160 starts the process of stopping the operation of the hydrogen compression stack 40. In step S8, the water electrolysis stack control unit 168 determines whether or not the process of stopping the operation of the water electrolysis stack 20 has been completed. If the determination result in step S8 is affirmative (YES), the process procedure proceeds to step S9. If the determination result in step S8 is negative (NO), the process procedure repeats the process of step S8.

In step S9, the hydrogen compression stack control unit 160 determines whether or not the process of stopping the operation of the hydrogen compression stack 40 has been completed. If the determination result in step S9 is affirmative (YES), the process procedure proceeds to step S10. If the determination result in step S9 is negative (NO), the process procedure repeats the process of step S9. In step S10, the discharge control unit 164 closes the discharge valve 128. In step S11, the supply control unit 162 closes the supply valve 124. When the process of step S11 is completed, the process procedure is ended.

It should be noted that, when the operation of the water electrolysis stack 20 is stopped, high-pressure oxygen gas is not generated. In that case, sufficient safety can be ensured. Therefore, the process of stopping the operation of the hydrogen compression stack 40 may not necessarily be performed.

The above-described embodiment may be modified as follows. In the following modification, description overlapping with that of the above-described embodiment will be omitted.

### (Modification)

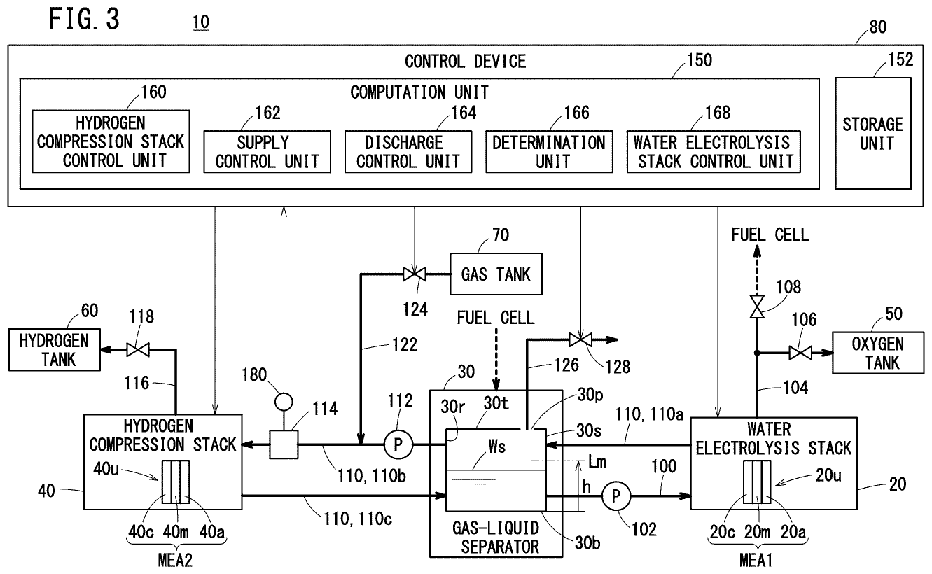

In the embodiment described above, the water electrolysis system 10 includes the concentration sensor 130 for measuring the oxygen concentration in the hydrogen flow path 110. However, instead of the oxygen concentration being measured by the concentration sensor 130, a catalyst temperature, which is the temperature of a catalyst provided in the oxygen removal device 114, may be measured. FIG. 3 is a diagram illustrating a configuration of the water electrolysis system 10 according to the present modification. The water electrolysis system 10 shown in FIG. 3 includes a temperature sensor 180 for measuring the catalyst temperature. Catalyst temperature information, which is information about the catalyst temperature measured by the temperature sensor 180, is supplied to the control device 80.

When the oxygen concentration in the hydrogen flow path 110 increases, a large amount of oxygen gas may come into contact with the catalyst in the oxygen removal device 114, and thus heat may be generated. Therefore, the determination unit 166 may determine that the oxygen concentration in the hydrogen flow path 110 has exceeded the oxygen concentration threshold, based on the catalyst temperature measured by the temperature sensor 180, and the correspondence relationship between the oxygen concentration and the catalyst temperature.

Specifically, in a case where the catalyst temperature exceeds a catalyst temperature threshold determined in advance, it is determined that the oxygen concentration in the hydrogen flow path 110 has exceeded the oxygen concentration threshold. The correspondence relationship between the oxygen concentration and the catalyst temperature is determined in advance by an experiment or the like, and is stored in the storage unit 152. Further, based on the correspondence relationship, the catalyst temperature threshold is determined in advance in correspondence with the above-described oxygen concentration threshold, and is stored in the storage unit 152.

When the start-up process for the water electrolysis system 10 is started, the determination unit 166 repeatedly acquires the catalyst temperature information from the temperature sensor 180. The determination unit 166 determines whether or not the oxygen concentration in the hydrogen flow path 110 has exceeded the oxygen concentration threshold based on the acquired catalyst temperature information. When the oxygen concentration increases, the catalyst temperature rises rapidly. Therefore, it is easy to detect that the oxygen concentration in the hydrogen flow path 110 has exceeded the oxygen concentration threshold.

In a case where the determination unit 166 determines that the oxygen concentration has exceeded the oxygen concentration threshold, the supply control unit 162 controls the supply valve 124 to open the supply valve 124. Further, the discharge control unit 164 controls the discharge valve 128 to open the discharge valve 128. Furthermore, the water electrolysis stack control unit 168 controls the water electrolysis stack 20 to start the process of stopping the operation of the water electrolysis stack 20. The hydrogen compression stack control unit 160 controls the hydrogen compression stack 40 to start the process of stopping the operation of the hydrogen compression stack 40.

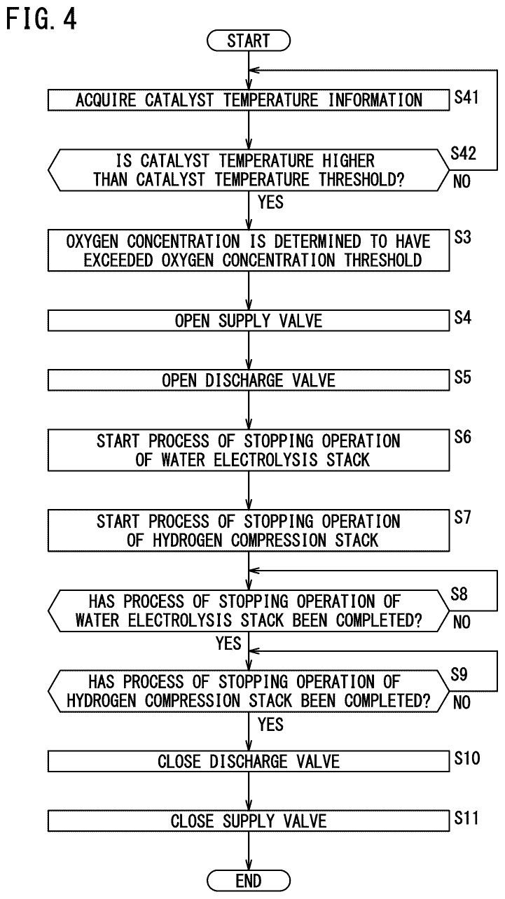

FIG. 4 is a flowchart showing an operation example of the control device 80. When the start-up process for the water electrolysis system 10 is started, the safety control process procedure for the water electrolysis system 10 shown in FIG. 4 is started. This process procedure is performed by the computation unit 150 of the control device 80 executing a program stored in the storage unit 152. The same steps as those described above with reference to FIG. 2 are denoted by the same reference numerals, and the description thereof will be appropriately omitted.

When this process procedure is started, the determination unit 166 acquires the catalyst temperature information from the temperature sensor 180 in step S41. In step S42, the determination unit 166 determines whether or not the catalyst temperature indicated by the catalyst temperature information acquired in step S41 is higher than the catalyst temperature threshold stored in the storage unit 152. If the determination result in step S42 is affirmative (YES), the process procedure proceeds to step S3. If the determination result in step S42 is negative (NO), the process procedure returns to step S41.

The following supplementary notes are further disclosed in relation to the above-described embodiment and modification.

### Supplementary Note 1

The water electrolysis system (10) according to the present disclosure includes: the water electrolysis stack (20) including the membrane electrode assembly (MEA1) in which the electrolyte membrane (20m) is sandwiched between the anode (20a) and the cathode (20c), the water electrolysis stack being configured to generate oxygen gas and hydrogen gas by electrolyzing water; the gas-liquid separator (30) configured to separate the hydrogen gas generated by the water electrolysis stack from water that has not been electrolyzed by the water electrolysis stack; the hydrogen compression stack (40) including the membrane electrode assembly (MEA2) in which the electrolyte membrane (40m) is sandwiched between the anode (40a) and the cathode (40c), the hydrogen compression stack being configured to compress the hydrogen gas separated by the gas-liquid separator; the gas tank (70) configured to store an inert gas and connected to the hydrogen flow path (110) that connects the water electrolysis stack and the hydrogen compression stack to each other via the gas-liquid separator; the supply valve (124) configured to, when opened, supply the inert gas stored in the gas tank to the hydrogen flow path; and the supply control unit (162) configured to open the supply valve in a case where the oxygen concentration, which is the concentration of the oxygen gas that has flowed into the hydrogen flow path, exceeds the oxygen concentration threshold determined in advance. According to such a configuration, safety when an abnormality occurs in the water electrolysis system can be improved.

### Supplementary Note 2

In the water electrolysis system according to Supplementary Note 1, the gas tank may be connected to the section (110b) of the hydrogen flow path, the section being located between the gas-liquid separator and the hydrogen compression stack. According to such a configuration, the inert gas can reduce the oxygen concentration in the hydrogen flow path, the oxygen removal device, and the hydrogen compression stack.

### Supplementary Note 3

The water electrolysis system according to Supplementary Note 1 may further include: the discharge flow path (126) communicating with the opening (30p) provided in the gas-liquid separator; the discharge valve (128) configured to, when opened, allow the discharge flow path to communicate with the outside; and the discharge control unit (164) configured to open the discharge valve in a case where the oxygen concentration exceeds the oxygen concentration threshold. According to such a configuration, the oxygen concentration in the hydrogen flow path is sufficiently reduced, and the safety of the water electrolysis system can be further improved.

### Supplementary Note 4

In the water electrolysis system according to Supplementary Note 3, the opening may be provided at a portion of the gas-liquid separator that is located above the storable water level (Lm) of the gas-liquid separator. According to such a configuration, the opening can be prevented from being submerged in the water in the gas-liquid separator.

### Supplementary Note 5

The water electrolysis system according to Supplementary Note 1 may further include the water electrolysis stack control unit (168) configured to control the water electrolysis stack to start the process of stopping the operation of the water electrolysis stack in a case where the oxygen concentration exceeds the oxygen concentration threshold. According to such a configuration, the generation of oxygen gas is suppressed, and the safety of the water electrolysis system can be therefore further improved.

### Supplementary Note 6

In the water electrolysis system according to Supplementary Note 5, the supply valve may be kept open until the operation of the water electrolysis stack is stopped. According to such a configuration, the generation of oxygen gas is stopped, and the safety of the water electrolysis system can be therefore further improved.

### Supplementary Note 7

The water electrolysis system according to Supplementary Note 5 may further include the hydrogen compression stack control unit (160) configured to control the hydrogen compression stack to start the process of stopping the operation of the hydrogen compression stack in a case where the oxygen concentration exceeds the oxygen concentration threshold. According to such a configuration, the possibility that the hydrogen gas and the oxygen gas supplied to the hydrogen compression stack react with each other is reduced, and the safety of the water electrolysis system can be therefore further improved.

### Supplementary Note 8

In the water electrolysis system according to Supplementary Note 7, the supply valve may be kept open until both the operation of the water electrolysis stack and the operation of the hydrogen compression stack are stopped. According to such a configuration, the safety of the water electrolysis system can be further improved.

### Supplementary Note 9

The water electrolysis system according to any one of Supplementary Notes 1 to 8 may further include: the catalyst disposed in the hydrogen flow path to remove the oxygen gas in the hydrogen flow path; and the determination unit (166) configured to determine that the oxygen concentration has exceeded the oxygen concentration threshold in a case where the catalyst temperature, which is the temperature of the catalyst, exceeds the catalyst temperature threshold determined in advance in correspondence with the oxygen concentration threshold based on the correspondence relationship between the oxygen concentration and the catalyst temperature, and the supply control unit may open the supply valve in a case where the determination unit determines that the oxygen concentration has exceeded the oxygen concentration threshold. According to such a configuration, it is easy to detect that the oxygen concentration in the hydrogen flow path has exceeded the oxygen concentration threshold.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis system, comprising:
a water electrolysis stack including a membrane electrode assembly in which an electrolyte membrane is sandwiched between an anode and a cathode, the water electrolysis stack being configured to generate oxygen gas and hydrogen gas by electrolyzing water;
a gas-liquid separator configured to separate the hydrogen gas generated by the water electrolysis stack from water that has not been electrolyzed by the water electrolysis stack;
a hydrogen compression stack including a membrane electrode assembly in which an electrolyte membrane is sandwiched between an anode and a cathode, the hydrogen compression stack being configured to compress the hydrogen gas separated by the gas-liquid separator;
a gas tank configured to store an inert gas and connected to a hydrogen flow path that connects the water electrolysis stack and the hydrogen compression stack to each other via the gas-liquid separator;
a supply valve configured to, when opened, supply the inert gas stored in the gas tank to the hydrogen flow path; and
one or more processors that execute computer-executable instructions stored in a memory,
wherein the one or more processors execute the computer-executable instructions to cause the water electrolysis system to open the supply valve in a case where an oxygen concentration, which is a concentration of oxygen gas that has flowed into the hydrogen flow path, exceeds an oxygen concentration threshold determined in advance.

2. The water electrolysis system according to claim 1, wherein
the gas tank is connected to a section of the hydrogen flow path, the section being located between the gas-liquid separator and the hydrogen compression stack.

3. The water electrolysis system according to claim 1, further comprising:
a discharge flow path communicating with an opening provided in the gas-liquid separator; and
a discharge valve configured to, when opened, allow the discharge flow path to communicate with an outside,
wherein the one or more processors cause the water electrolysis system to open the discharge valve in the case where the oxygen concentration exceeds the oxygen concentration threshold.

4. The water electrolysis system according to claim 3, wherein
the opening is provided at a portion of the gas-liquid separator that is located above a storable water level of the gas-liquid separator.

5. The water electrolysis system according to claim 1, wherein
the one or more processors cause the water electrolysis system to control the water electrolysis stack to start a process of stopping an operation of the water electrolysis stack in the case where the oxygen concentration exceeds the oxygen concentration threshold.

6. The water electrolysis system according to claim 5, wherein
the supply valve is kept open until the operation of the water electrolysis stack is stopped.

7. The water electrolysis system according to claim 5, wherein
the one or more processors cause the water electrolysis system to control the hydrogen compression stack to start a process of stopping an operation of the hydrogen compression stack in the case where the oxygen concentration exceeds the oxygen concentration threshold.

8. The water electrolysis system according to claim 7, wherein
the supply valve is kept open until both the operation of the water electrolysis stack and the operation of the hydrogen compression stack are stopped.

9. The water electrolysis system according to claim 1, further comprising a catalyst disposed in the hydrogen flow path to remove oxygen gas in the hydrogen flow path, wherein
the one or more processors cause the water electrolysis system to:
determine that the oxygen concentration has exceeded the oxygen concentration threshold in a case where a catalyst temperature, which is a temperature of the catalyst, exceeds a catalyst temperature threshold that is determined in advance in correspondence with the oxygen concentration threshold based on a correspondence relationship between the oxygen concentration and the catalyst temperature; and
open the supply valve in a case where it is determined that the oxygen concentration has exceeded the oxygen concentration threshold.
